(19) United States
(12) Patent Application Publication
(10) Pub. No.: US 2017/0295598 A1
(43) Pub. Date: Oct. 12, 2017

(54) RELAYING BASED ON SERVICE-TYPE INDICATOR AND NETWORK AVAILABILITY

(71) Applicant: QUALCOMM Incorporated, San Diego, CA (US)

(72) Inventors: Karl Georg Hampel, New York, NY (US); Vincent Douglas Park, Budd Lake, NJ (US); Junyi Li, Chester, NJ (US)

(21) Appl. No.: 15/093,517

(22) Filed: Apr. 7, 2016

(51) Int. Cl. H04W 76/02

(52) U.S. Cl. CPC H04W 76/02; H04W 88/04

(57) ABSTRACT

Methods, systems, and devices for wireless communication are described. A user equipment (UE) may act as a relay device and receive a message from a source device. The message may be a broadcast message and may include a service type indicator. The UE may identify a capability configuration for the UE that is associated with the UE communicating via a first air interface with the source device and at least one other air interface. The UE may establish a connection to the source device on the air interface based on the capability configuration and the service type indicator.

### BACKGROUND

The following relates generally to wireless communication, and more specifically to relaying based on service-type indicator and network availability.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may each be referred to as a user equipment (UE). A wireless network may also include components of a WLAN, such as a Wi-Fi (i.e., IEEE 802.11) network, and may include access points (APs) that may communicate with at least one UE or station (STA).

Other wireless devices may also be deployed and may have limited available power and also a limited means to directly connect to a wireless network, e.g., due to the costs associated with equipping such devices with the hardware and subscription costs associated with cellular communications. While WLAN (e.g., Wi-Fi) hardware and associations may be an alternative, this may also be difficult due to limited coverage areas, upkeep in linking with changing configurations and settings, etc. Another aspect of such wireless devices, e.g., wearable devices, sensor nodes, internet-of-things (IoT) devices, etc., is that they may have a limited amount of information to convey and, in many cases, that information is not necessarily time-sensitive, e.g., as compared to real-time communications. When such wireless devices need to relay data or access other services, they may attempt to connect to a nearby device, e.g., a UE, in order for the UE to provide such services. This connection typically includes various overhead messaging to establish and secure the connection. The UE, however, may not be able to support every type of service that the wireless device needs to access and therefore the connection will be unnecessary.

### SUMMARY

The present disclosure relates to improved techniques that support relaying based on service-type indicator and network availability. Generally, the described techniques provide for a smart device, such as a UE for example, to act as a relay device (or a device that support other service(s)) and receive a broadcast message from a source device. The broadcast message may be received on a first air interface (e.g., Bluetooth (BT), BT Low Energy (BTLE), Zigbee, etc.) from the source device and may include a service type indicator. The service type indicator may provide some indication of the nature of the service that the source device is requesting. The UE may identify a capability configuration indicative of the services that the UE can support. The capability configuration may, in some examples, indicate whether the UE can support communications with the source device in addition to communications with another device via the same or a different air interface, e.g., a concurrent connection. In one example of a concurrent connection, the first air interface with the source device is a short range air interface (e.g., BT) and a second interface with the other device is a cellular or Wi-Fi air interface. Thus, the UE may establish a connection to the source device on the first air interface based on the capability configuration and the service type indicator. For example, the UE may determine, based on the capability configuration, that the UE can support the requested service, as indicated by the service type indicator, from the source device and establish the necessary connection.

A method of wireless communication is described. The method may include receiving, at a relay device, a broadcast message from a source device on a first air interface, the broadcast message comprising a service type indicator, identifying a capability configuration of the relay device, the capability configuration comprising information associated with communicating via the first air interface and at least a second air interface and determining to establish a connection to the source device on the first air interface based at least in part on the capability configuration and the service type indicator.

An apparatus for wireless communication is described. The apparatus may include means for receiving, at a relay device, a broadcast message from a source device on a first air interface, the broadcast message comprising a service type indicator, means for identifying a capability configuration of the relay device, the capability configuration comprising information associated with communicating via the first air interface and at least a second air interface and means for determining to establish a connection to the source device on the first air interface based at least in part on the capability configuration and the service type indicator.

A further apparatus is described. The apparatus may include a processor, memory in electronic communication with the processor, and instructions stored in the memory. The instructions may be operable to cause the processor to receive, at a relay device, a broadcast message from a source device on a first air interface, the broadcast message comprising a service type indicator, identify a capability configuration of the relay device, the capability configuration comprising information associated with communicating via the first air interface and at least a second air interface and determine to establish a connection to the source device on the first air interface based at least in part on the capability configuration and the service type indicator.

A non-transitory computer readable medium for wireless communication is described. The non-transitory computer-readable medium may include instructions to cause a processor to receive, at a relay device, a broadcast message from a source device on a first air interface, the broadcast message comprising a service type indicator, identify a capability configuration of the relay device, the capability configuration comprising information associated with communicating via the first air interface and at least a second air interface and determine to establish a connection to the source device on the first air interface based on the capability configuration and the service type indicator.

Some examples of the method, apparatus, or non-transitory computer-readable medium described above may further include processes, features, means, or instructions for determining to establish the connection to the source device based on the capability configuration being within a threshold level of a requested service indicated by the service type indicator.

In some examples of the method, apparatus, or non-transitory computer-readable medium described above, the service type indicator comprises an indication of at least one of a concurrent connection request on the first air interface and the second air interface, a delay tolerant message forwarding request, a request for information, or combinations thereof. In some examples of the method, apparatus, or non-transitory computer-readable medium described above, the capability configuration comprises an indication of one or more services supported by the relay device via at least one of the first air interface and the second air interface.

In some examples of the method, apparatus, or non-transitory computer-readable medium described above, the broadcast message comprises a connection request message. In some examples of the method, apparatus, or non-transitory computer-readable medium described above, the service type indicator comprises a concurrent connection request, the concurrent connection comprising a first connection between the relay device and the source device on the first air interface and a second connection between the relay device and a remote server on the second air interface.

In some examples of the method, apparatus, or non-transitory computer-readable medium described above, at least one of the first air interface or the second air interface comprises a connection over a same air interface. In some examples of the method, apparatus, or non-transitory computer-readable medium described above, at least one of the first air interface or the second air interface comprises a connection over a different air interface.

In some examples of the method, apparatus, or non-transitory computer-readable medium described above, at least one of the first connection or the second connection comprises a connection over a licensed radio frequency spectrum band. In some examples of the method, apparatus, or non-transitory computer-readable medium described above, at least one of the first connection or the second connection comprises a connection over an unlicensed radio frequency spectrum band.

### BRIEF DESCRIPTION OF THE DRAWINGS

FIG. 1 illustrates an example of a wireless communications system that supports relaying based on service-type indicator and network availability in accordance with aspects of the present disclosure;

FIG. 2 illustrates an example of a wireless communications system that supports relaying based on service-type indicator and network availability in accordance with aspects of the present disclosure;

FIG. 3 illustrates an example of a method flow in a system that supports relaying based on service-type indicator and network availability in accordance with aspects of the present disclosure;

FIG. 4 illustrates an example of a method flow that supports relaying based on service-type indicator and network availability in accordance with aspects of the present disclosure;

FIG. 5 illustrates an example of a method flow in a system that supports relaying based on service-type indicator and network availability in accordance with aspects of the present disclosure;

FIG. 6 illustrates an example of a process flow in a system that supports relaying based on service-type indicator and network availability in accordance with aspects of the present disclosure;

FIG. 7 illustrates an example of a process flow in a system that supports relaying based on service-type indicator and network availability in accordance with aspects of the present disclosure;

FIG. 8 illustrates an example of a process flow in a system that supports relaying based on service-type indicator and network availability in accordance with aspects of the present disclosure;

FIGS. 9 through 11 show block diagrams of a wireless device that supports relaying based on service-type indicator and network availability in accordance with aspects of the present disclosure;

FIG. 12 illustrates a block diagram of a system including a UE that supports relaying based on service-type indicator and network availability in accordance with aspects of the present disclosure; and

FIGS. 13 through 14 illustrate methods for relaying based on service-type indicator and network availability in accordance with aspects of the present disclosure.

### DETAILED DESCRIPTION

Certain wireless devices (referred to as source devices) may not be equipped for communications via every available air interface. For example, the cost and/or complexity associated with a cellular air interface, such as a Long Term Evolution (LTE)/LTE-Advanced (LTE-A) network may be inappropriate for sensor devices, wearable devices, internet-of-things (IoT) devices, etc. While a Wireless Local Area Network (WLAN) may be somewhat less costly, at least from a subscription perspective, these Wi-Fi networks typically require close proximity to the source device and/or can include complicated association overhead. The source devices may support environmental measurements, structural health monitoring, smart-city applications, health or location tracking applications, usage monitoring of various electrical devices, etc. These source devices, however, typically rely on other smart devices, such as a nearby UE, to provide various services, e.g., relay services, concurrent connection services, local connection services, etc. Conventionally, a source device that has a need for a service will broadcast a connection request message, or similar type message, to establish a connection with a UE to receive the service. Not every UE, however, is equipped or otherwise configured to support every service for a source device.

Aspects of the disclosure are initially described in the context of a wireless communication system. Aspects of the present disclosure relate to a UE determining whether to establish a connection with a source device based on a service type indicator received from the source device. For example, the UE may act in a relay device capacity and receive a broadcast message from the source device, e.g., a connection request message. The broadcast message may include a bit, information element, field, pointer, etc., that conveys a service type indicator associated with the type of service the source device is requesting the connection for. The UE may determine or identify a capability configuration of the UE. Broadly, the capability configuration may provide an indication of the types of services that the UE can support. In one example, the capability configuration is associated with the UE communicating on more than one air interface. The UE may determine whether to establish a connection to the source device based on the capability configuration and the service type indicator. As one example, when the capability configuration indicates that the UE can support the type of service associated with the service type indicator (e.g., is within a threshold level), the UE may establish the connection via an air interface. Accordingly, when the capability configuration indicates that the UE cannot support the requested service, the UE may refrain from establishing a connection with the source device, e.g., respond with a connection rejection or not respond at all to the source device.

Aspects of the disclosure are further illustrated by and described with reference to apparatus diagrams, system diagrams, and flowcharts that relate to relaying based on service-type indicator and network availability.

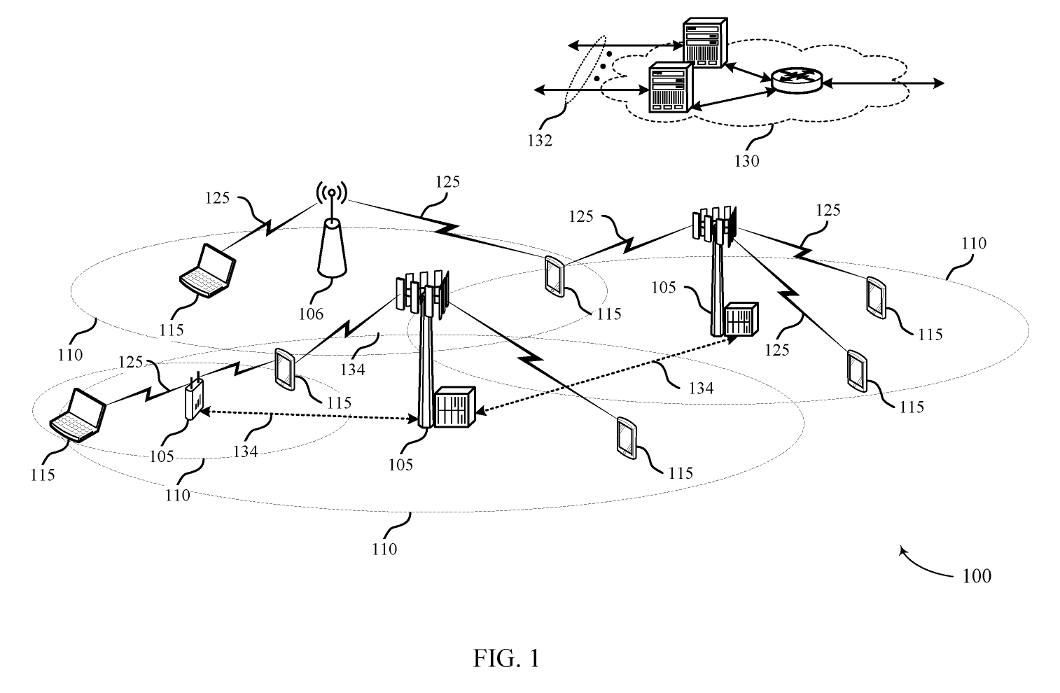

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, a machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

The wireless communications system 100 may also include at least one access point (AP) 106, which may communicate with UEs 115 such as mobile stations, personal digital assistant (PDAs), other handheld devices, netbooks, notebook computers, tablet computers, laptops, display devices (e.g., TVs, computer monitors, etc.), printers, etc. In some cases the AP 106 may be a component of a WLAN, which may be a trusted WLAN associated with the WWAN of wireless communications system 100. The AP 106 and the associated UEs 115 may represent a basic service set (BSS) or an extended service set (ESS). The various UEs 115 in the network are able to communicate with one another through the AP 106. Also shown is a coverage area 110 of the AP 106, which may represent a basic service area (BSA) of the wireless communications system 100. An extended network station (not shown) associated with the wireless communications system 100 may be connected to a wired or wireless distribution system that may allow multiple APs 106 to be connected in an ESS.

Wireless communications system 100 may support operation on multiple cells or carriers, a feature which may be referred to as carrier aggregation (CA) or multi-carrier operation. A carrier may also be referred to as a component carrier (CC), a layer, or the like. The terms “carrier,” “component carrier,” and “cell” may be used interchangeably herein. A UE 115 may be configured with multiple downlink CCs and one or more uplink CCs for carrier aggregation. Carrier aggregation may be used with both FDD and TDD component carriers.

In some cases, wireless communications system 100 may utilize enhanced CCs (eCC). An enhanced component carrier (eCC) may be characterized by one or more features including: wider bandwidth, shorter symbol duration, shorter transmission time interval (TTIs), and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 MHz., etc.) at reduced symbol durations (e.g., 16.67 μs). A TTI in eCC may consist of one or multiple symbols. In some cases, the TTI duration (that is, the number of symbols in a TTI) may be variable. In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 MHz., etc.) at reduced symbol durations (e.g., 16.67 μs). A TTI in eCC may consist of one or multiple symbols. In some cases, the TTI duration (that is, the number of symbols in a TTI) may be variable.

Wireless communications system 100 may be a heterogeneous wireless network that supports communications using a variety of air interfaces. In some aspects, the supported air interfaces may be a set of air interfaces that are available for wireless communications. Each air interface may be associated with a different radio access technology (RAT), such as a cellular RAT, a Wi-Fi RAT, a Bluetooth (BT) RAT, a ZigBee RAT, etc. Additionally or alternatively, each air interface may be associated with a different wireless network operator, a different public land mobile network (PLMN), etc. Additionally or alternatively, each air interface may be associated with a licensed radio frequency spectrum band and/or an unlicensed radio frequency spectrum band. The UEs 115 may support communications on a variety of different air interfaces, e.g., cellular, Wi-Fi, BT, etc.

In certain aspects, UE(s) 115 may support relaying based on a service type indicator and the network availability. For example, a UE 115 may be configured or act as a relay device. The UE 115 may receive a message from a source device that includes a service type indicator. The message may be a broadcast message such as a connection request message. The UE 115 may identify a capability configuration of the UE 115, e.g., an indication of the services that the UE 115 can support. In some examples, the capability configuration may be associated with a determination of whether the UE 115 can support communicating with the source device on a first air interface and communicating on a second air interface. The UE 115 may determine to establish a connection to the source device based on the capability configuration and the service type indicator, e.g., based on the capability configuration indicating that the UE 115 can support the service indicated in the service type indicator.

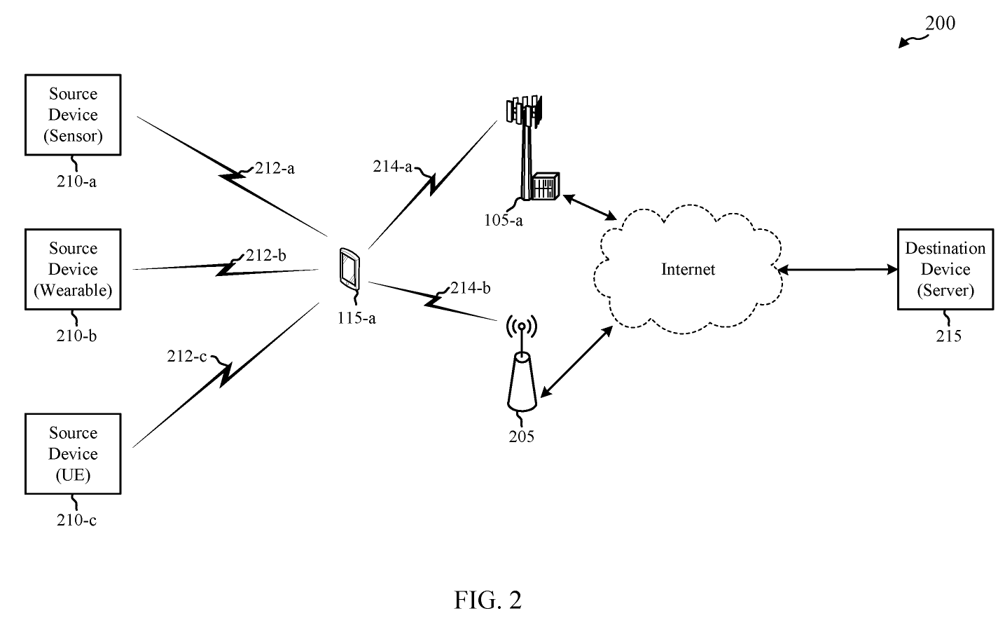

FIG. 2 illustrates an example of a wireless communications system 200 for relaying of traffic based on a service type indicator and network availability. Wireless communications system 200 may include base station 105-a, an AP 106-a, and UE 115-a, which may be examples of the corresponding devices described with reference to FIG. 1. Wireless communications system 200 may also include source devices 210 and a destination device 215. Broadly, wireless communications system 200 illustrates an example where source devices 210 pass messages to UE 115-a via a short-range air interface technology that includes a service type indicator. The UE 115-a reads the service type indicator and determines a capability configuration indicative of whether the UE 115-a can support the requested service. If so, the UE 115-a may determine to establish a connection with the source device 210 to provide the service.

Source devices 210 may include a variety of different devices. For example, source device 210-a may be a sensor device, such as an environmental sensor, a mechanical sensor, a health monitoring sensor, and the like. As another example, source device 210-b may be a wearable device such a smart watch, an IoT device, a fitness device, and the like. As yet another example, source device 210-c may be another UE 115. Source devices 210, in some examples, may not be configured for communications on certain air interfaces, e.g., Wi-Fi and/or cellular air interfaces. For example, the monetary costs associated with hardware/subscriptions to such air interfaces may be prohibitive, e.g., cellular RATs. In other examples, the coverage areas for different air interfaces may not support communications with source devices 210, e.g., Wi-Fi RATs and/or hotspots.

Source devices 210-a through 210-c may communicate with UE 115-a via first air interface 212-a through 212-c, respectively. In some examples, first air interfaces 212 may be considered short range air interfaces, although they are not limited to short range air interfaces. Each of first air interfaces 212 may be the same or different air interfaces. Examples of first air interfaces 212 may include, but are not limited to, a BT air interface, a BT Low Energy air interface, a near-field communication (NFC) air interface, a ZigBee air interface, an infrared air interface, and the like. The first air interfaces 212 may utilize licensed and/or unlicensed radio frequency spectrum bands. The first air interfaces 212 may also be examples of direct communications, such as device-to-device (D2D) air interfaces, Wi-Fi direct air interfaces, peer-to-peer (P2P) air interfaces, etc.

Source devices 210 may have services that may be supported by UE 115-a. Examples of such services may include, but are not limited to, a relay service where the UE 115-a relays message(s) (e.g., data, control information, etc.) to destination device 215, which may be a data aggregator, cloud server, remote server, etc. In some examples, the messages may be small data messages and/or large data messages. In some examples, the messages may have a low duty cycle in that the source devices 210 only transmits the messages once per hour, day, week, month, etc. Moreover, the messages may be delay tolerant messages and may be associated with a timeframe for delivery of the message. The timeframe may be based on a hard delivery deadline for the message, e.g., by a certain time on a certain day. The timeframe may be based on a delivery window for the message, e.g., a period when the message can be delivered and/or is expected to be delivered. The timeframe may be based on a priority level associated with the message, e.g., high priority messages are delivered within a certain time period, low priority messages may be delivered within a longer time period, etc. The timeframe may also be based on a data type associated with the message, e.g., certain data types are more delay tolerant than other data types. The timeframe may also be based on the type of source device 210, e.g., certain sensors may support longer delay tolerances than other

Another example of a service type may include a concurrent connection service where the UE 115-a establishes a first connection to source device 210 via air interface 212 and a second connection to destination device 215, via base station 105-a or AP 106-a on second air interface 214. The concurrent connection service may include the UE 115-a relaying, in real time, traffic from source device 210 to destination device 215, and vice versa. In some examples, first air interface 212 and second air interfaces are the same air interface or are different air interfaces. In one non-limiting example, the first air interface 212 is a BT Low Energy air interface and the second air interface is a cellular or Wi-Fi air interface.

Another example of a service type may include a local service, such as a request for information. Examples of such information may include, but are not limited to, timing information, location based information, etc. Accordingly, the type of service may include the source device 210 requesting that the UE 115-a provide such information.

Although the present description refers to the concurrent connection service, the relay service, and the information request service, it is to be understood that other services may also be requested. As non-limiting examples, services may be related to security services (e.g., key, count values, group IDs, etc.), network support services (e.g., network configuration parameters, timing features, messaging protocols, etc.), and the like. Specifically, the presently described service type indicator provided in the broadcast message from the source device 210 may support any services associated with the source device 210.

In some aspects, the described techniques may include the service type indicator being included in a wireless broadcast message. The broadcast message may be broadcast on one of a BT, BT Low Energy, a Zigbee, a Wi-Fi, or an LTE-D air interface. In some aspects, the service type indicator may point to an entry in a service type table which is shared between source devices 210 and UE 115-a. In some aspects, such table entries may include a “local connection” service request, e.g., a connection limited to the source device 210 and UE 115-a, a “delay-tolerant message forwarding” service request, e.g., no concurrent connection needed to a network (e.g., destination device 215, an “end-to-end connection with the network” service request, e.g., a concurrent connections needed between the source device 210 and UE 115-a and between UE 115-a to destination device 215.

In some aspects, the service type indicator may specify a latency tolerance for the establishment of the UE 115-a to network link. This latency tolerance may be specified via a pointer to a table with predefined entries such as 0, 1 h, 1 day, . . . , infinity, etc., or it may be specified as a value referring to a time metric, e.g., “latency in hours”.

Aspects of the disclosure provide for source devices 210 to use the community of existing smart devices, such as UE 115-a to support requested services in a deliberate manner. The density of smart devices within a given area may be considerable and, in many circumstances, the smart devices may support cellular and Wi-Fi air interface communications to provide access to the internet, such as second air interfaces 214. Such smart devices may also support communications on air interfaces operable with source devices 210, such as first air interfaces 212. Although the describes techniques generally use examples of short range air interface technologies, such as BT, ZigBee, etc., as the first air interfaces 212, it is to be understood that first air interfaces 212 may also be longer range air interface technologies, such as cellular, Wi-Fi, LTE Direct, etc.

As the number, density, etc., of source devices 210 continue to increase, aspects of the present disclosure may support service support by the UE 115-a and the source devices 210. UE 115-a may, in some examples, determine whether it can support the type of service being requested from the source device 210 and, if so, establish a connection to the source device 210 to provide the service. If the UE 115-a cannot support the requested service, the UE 115-a may refrain from establishing the connection and thereby conserve resources, overhead, etc.

Thus, in some aspects UE 115-a may be a relay device (e.g., configured to support a requested service). UE 115-a may receive a message from a source device 210 via a first air interface 212. The message may be a broadcast message and may include a service type indicator. The service type indicator may provide an indication of the type of service that the source device 210 is requesting. The UE 115-a may determine a capability configuration indicative of whether the UE 115-a can support the requested service. In the example of a relay service, the UE 115-a may determine the capability configuration by using the service type indicator included in the message. For example, the service type indicator may provide an indication of a timeframe for delivery of a delay tolerant message, e.g., delivery deadline for the message, a delivery window for the message, a priority level associated with the message, a data type associated with the message, a type of source device 210 sending the message, etc. The capability configuration may provide an indication of the urgency of sending the delay tolerant message to the destination device 215. The UE 115-a may determine, based on the capability configuration and the service type indicator, that the UE 115-a can support the requested service, e.g., relaying the delay tolerant message to the destination device within the appropriate time frame.

As another example of determining the capability configuration for a concurrent connection service request, the UE 115-a may use the service type indicator to determine whether the UE 115-a may support an active connection with the source device 210 on the first air interface and an active connection to destination device 215, via base station 105-a or AP 106-a on the second air interface 214. For example, the two active connections may be associated with different transceiver chains on the UE 115-a, e.g., more than one transmit/receive chain on the UE 115-a. When the UE 115-a is configured with only one transceiver chain, the UE 115-a may determine that it cannot support the concurrent connection. Also, when the UE 115-a is otherwise busy, e.g., performing communications, internet access, etc., that are not associated with the requested service, the UE 115-a may determine that it cannot support the requested service. As another example, the UE 115-a may determine whether it can support communicating with the destination device 215, e.g., based on different network operators.

In some aspects, the capability configuration may be based on a network availability of the UE 115-a. In some aspects, network availability may refer to the UE 115-a ability to exchange data with the network via a wireless link, e.g., data with destination device 215 via second air interfaces 214. Network availability may be based on signal-strength measurements of beacon signals transmitted by AP 106-a or base station 105-a pertaining to the network. It may further refer to the UE 115-a sharing state with such an AP 106-a or base station 105-a. Network availability may also refer to the UE 115-a being registered on a network, such as a cellular network, or associated with a network, such as a Wi-Fi hotspot. Network availability may also refer to UE 115-a having a connection established to a cellular network, or being in the state of exchanging traffic with a network, e.g., for a web browsing session. Network availability may refer to applying policies that restrict availability to a subset of networks, e.g., those networks that are free of charge, use only unlicensed spectrum, or belong to a pre-configured set (e.g., home network). The interpretation of network availability therefore may include specific policies enforced by the UE 115-a that determine when the UE 115-a is able to support the service requested by the source device 210.

In some examples, UE 115-a may limit accepting such service requests to times when the UE 115-a has network availability. This may, however, reduce the potential benefit such services may have, e.g., concurrent connection services. The source device 210, for instance, may support forwarding data to the UE 115-a with the service type indicator providing a request to pass the data (e.g., the delay tolerant messages) on at a later time. Such delay-tolerant message forwarding provides for the connection between source device 210 and UE 115-a to be brief in duration, which limits resource consumption on both devices. Further, the amount of UEs 115 (such as UE 115-a) that can be used for forwarding delay tolerant messages substantially increases since it also includes UEs 115 without current network connection availability. In particular, the relay service request may now include or be supported by UEs 115 that have stringent policy restrictions on the network selection for such forwarding tasks, e.g., such as the UE's 115 home network only.

As another example of determining the capability configuration for a concurrent connection service request, the UE 115-a may use the service type indicator to determine whether the UE 115-a may support providing information to the source device 210. For example, the source device 210 may desire connectivity to UE 115-a solely to exchange local data, e.g., to determine the current time, their current location, etc. For these purpose, the UE's network availability may not be considered and, instead, the UE 115-a may determine whether it has (or has access to) the type of information being requested, as indicated by the service type indicator.

Based on the service type indicator and the capability configuration, the UE 115-a may determine whether to establish a connection to the source device 210 to provide the requested service. Thus, the described techniques provide for the UE 115-a to learn about the source device 210′s intentions behind the connection request prior to accepting it. This may be accomplished by having the source device 210 include a service-type indicator into the advertising message broadcast on the device-to-device wireless interface. The service-type indicator allows the UE 115-a to determine the need for network availability or the delay tolerance to such network availability. Based on this determination and the actual or projected network availability, the UE 115-a may make an informed decision whether to connect to the source device 210.

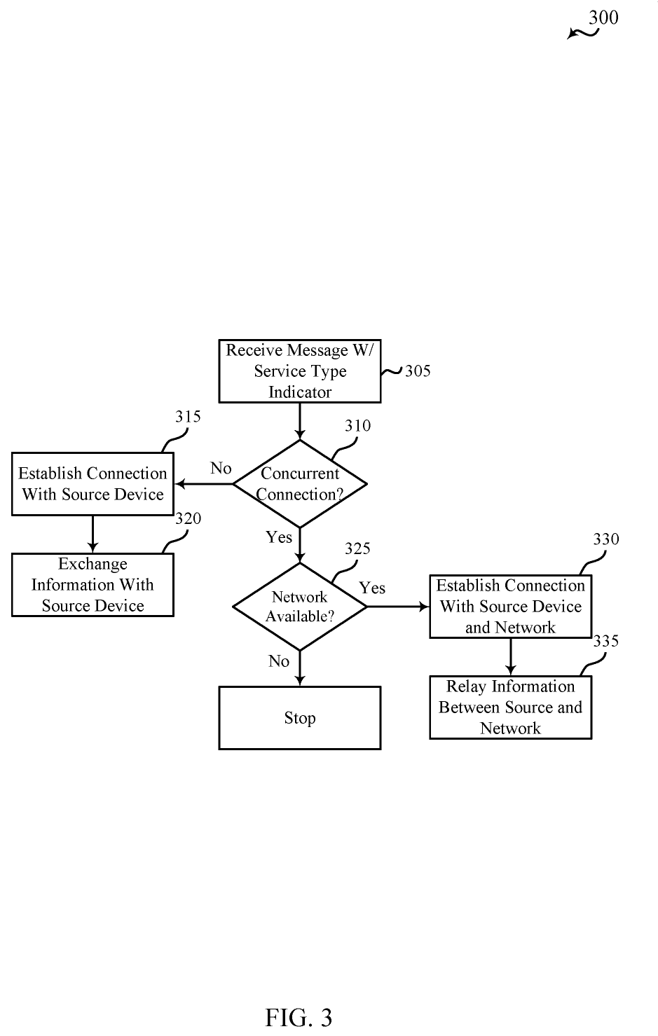

FIG. 3 shows a method flow 300 for relaying based on a service type indicator and network availability, in accordance with various aspects of the present disclosure. The operations of method flow 300 may be implemented by a device such as a UE 115 or its components as described with reference to FIGS. 1 and 2. In some examples, the UE 115 may execute a set of codes to control the functional elements of the device to perform the functions described below. Additionally or alternatively, the UE 115 may perform aspects the functions described below using special-purpose hardware. Generally, method flow 300 illustrates an example where the UE 115 evaluates a need for concurrent connectivity.

At 305, the UE 115 may receive a service type indicator in a broadcast message from a source device. The broadcast message may be, in some examples, a connection request message. At 310, the UE 115 may use the service type indicator to determine whether there is a need for concurrent connections to the network and to the source device. For example, the service type indicator may provide an indication that the source device requests a concurrent connection service from the UE 115. The UE 115 may make the determination based on a mapping from a table entry pointed to by the service type indicator, in some examples. The determination may also be based on a mapping from a specific value or a range of values specified by a value of the service type indicator. In an example where the service type indicator refers to a latency tolerance metric, a zero-valued latency tolerance may imply a request for a concurrent connections, for example.

If the UE 115 determines that such concurrent connectivity is requested, at 315 the UE 115 establishes a connection to the source device. At 320, the UE 115 may receive data, information, etc., from the source device or, in some examples, may forward data or information to the source device. If the UE determines that a concurrent connection is being requested, at 325 the UE 115 may determine if a network is available to support the concurrent connection. This determination may be based on the UE 115 evaluating network availability before connecting to the source device. If there is no network determined available, the method flow 300 stops. If there is a network available, at 330 the UE 115 connects to the source device as well as to the network. At 335, the UE 115 may relay data, information, etc., between the source device and the network, e.g., a destination device. Thus, in the situation where there is no network available and UE 115 cannot support the requested concurrent connection service, the UE 115 and the source device will conserve the resources that might otherwise have been used to establish a connection.

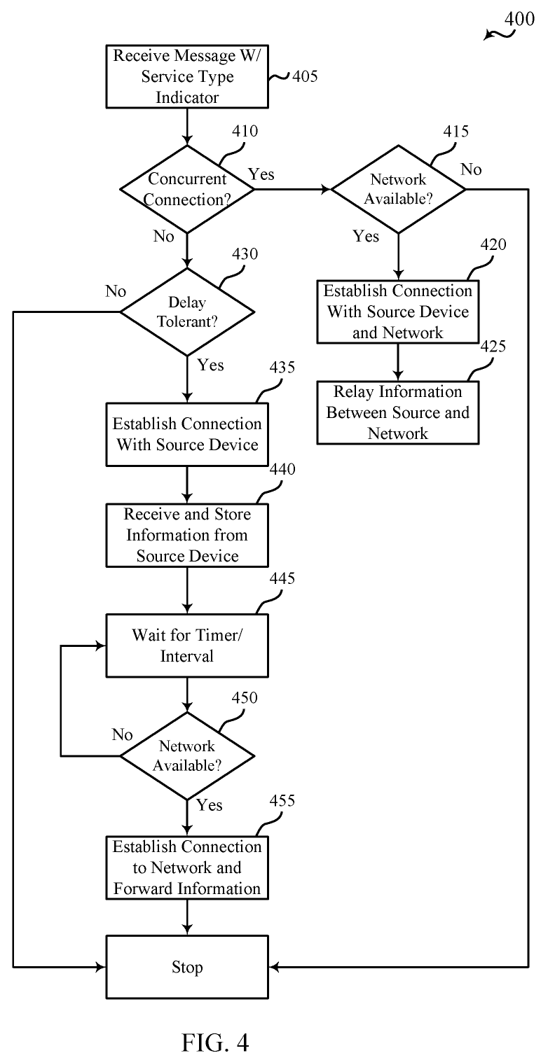

FIG. 4 shows a method flow 400 for relaying based on a service type indicator and network availability, in accordance with various aspects of the present disclosure. The operations of method flow 400 may be implemented by a device such as a UE 115 or its components as described with reference to FIGS. 1 and 2. In some examples, the UE 115 may execute a set of codes to control the functional elements of the device to perform the functions described below. Additionally or alternatively, the UE 115 may perform aspects the functions described below using special-purpose hardware. Generally, method flow 400 illustrates an example where the UE 115 evaluates a need for concurrent connectivity and for delay tolerant message forwarding.

At 405, the UE 115 may receive a service type indicator in a broadcast message from a source device. The broadcast message may be, in some examples, a connection request message. At 410, the UE 115 may use the service type indicator to determine whether there is a need for concurrent connections to the network and to the source device. If the UE 115 determines that concurrent connectivity is being requested, at 415 the UE 115 determines if there is network availability. If a network is available, at 420 the UE 115 may connect to the source device as well as to the network and at 425 the UE 115 may relay data between both entities. If a network is not available, the UE 115 may not connect to the source device, and hence conserves the resource that would otherwise be used for the connection.

If concurrent connectivity is not being requested, at 430 the UE 115 uses the service type indicator to determine if delay tolerant message forwarding is being requested. If message forwarding is being requested, at 435, the UE 115 connects to the source device and at 440 receives and stores data from the source device. At 445, the UE 115 may wait for a timer/interval value to be reached associated with forwarding delay tolerant message. Once the timer/interval value has been reached, at 450 the UE 115 may determine whether there is network availability. If there is network availability, at 455 the UE 115 may establishes a network connection and forwards the data or information to the destination device. If there is no network availability at 450, method flow 400 may return to 455 where the UE 115 periodically reevaluates network availability and forwards the data once network availability has been confirmed. The evaluation may be based on wait-time intervals or based on interrupts sent by other processes on the UE 115.

In one example where the UE 115 determines neither the need for a concurrent connection nor the need for a delay-tolerant message forwarding, the UE 115 may refrain from connecting to the source device, and hence conserves the resources that would have been used for such a connection.

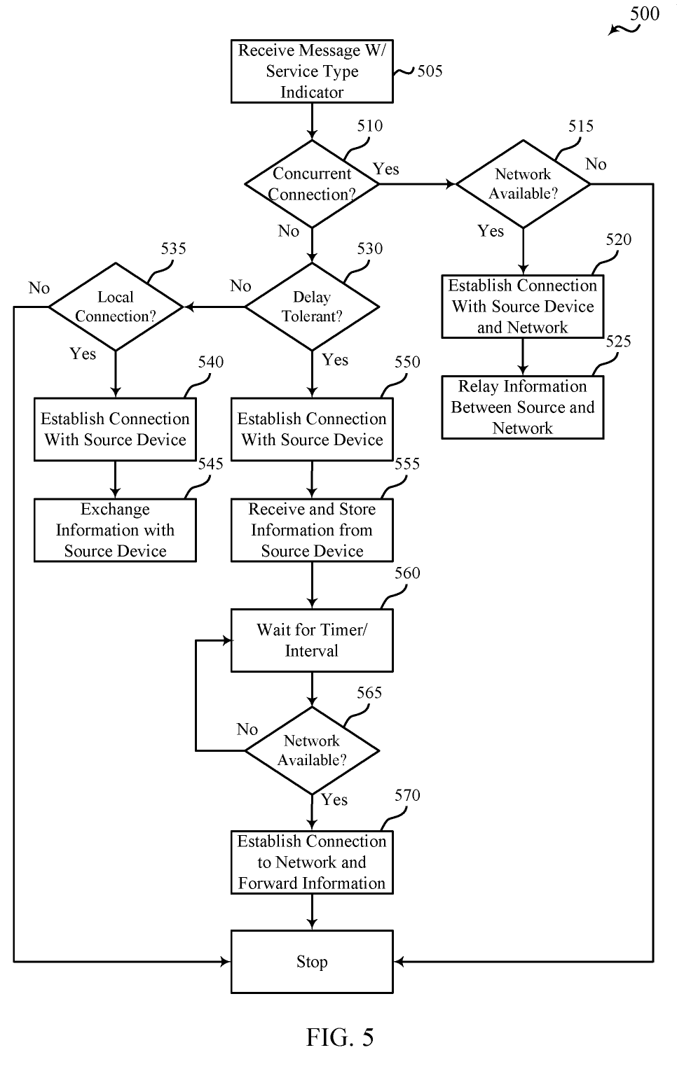

FIG. 5 shows a method flow 500 for relaying based on a service type indicator and network availability, in accordance with various aspects of the present disclosure. The operations of method flow 500 may be implemented by a device such as a UE 115 or its components as described with reference to FIGS. 1 and 2. In some examples, the UE 115 may execute a set of codes to control the functional elements of the device to perform the functions described below. Additionally or alternatively, the UE 115 may perform aspects the functions described below using special-purpose hardware. Generally, method flow 400 illustrates an example where the UE 115 evaluates a need for concurrent connectivity, for delay tolerant message forwarding, or for a local connection.

At 505, the UE 115 may receive a service type indicator in a broadcast message from a source device. The broadcast message may be, in some examples, a connection request message. At 510, the UE 115 may use the service type indicator to determine whether there is a need for concurrent connections to the network and to the source device. If the UE 115 determines that concurrent connectivity is being requested, at 515 the UE 115 determines if there is network availability. If a network is available, at 520 the UE 115 may connect to the source device as well as to the network and at 525 the UE 115 may relay data between both entities. If a network is not available, the UE 115 may not connect to the source device, and hence conserves the resource that would otherwise be used for the connection.

If concurrent connectivity is not being requested, at 530 the UE 115 uses the service type indicator to determine if delay tolerant message forwarding is being requested. If message forwarding is not being requested, at 535 the UE 115 may use the service type indicator to determine whether a local connection service is being requested. If a local connection is being requested, at 540 the UE 115 may establish a connection with the source device and at 545 may exchange information with the source device. If no local connection is being requested, the UE 115 may not connect to the source device, and hence conserves the resources that would otherwise be used for the connection.

If message forwarding is being requested at 530, at 550 the UE 115 connects to the source device and at 555 receives and stores data from the source device. At 560, the UE 115 may wait for a timer/interval value to be reached associated with forwarding delay tolerant message. Once the timer/interval value has been reached, at 565 the UE 115 may determine whether there is network availability. If there is network availability, at 570 the UE 115 may establishes a network connection and forward the data or information to the destination device. If there is no network availability at 565, method flow 500 may return to 560 where the UE 115 periodically reevaluates network availability and forwards the data once network availability has been confirmed. The evaluation may be based on wait-time intervals or based on interrupts sent by other processes on the UE 115.

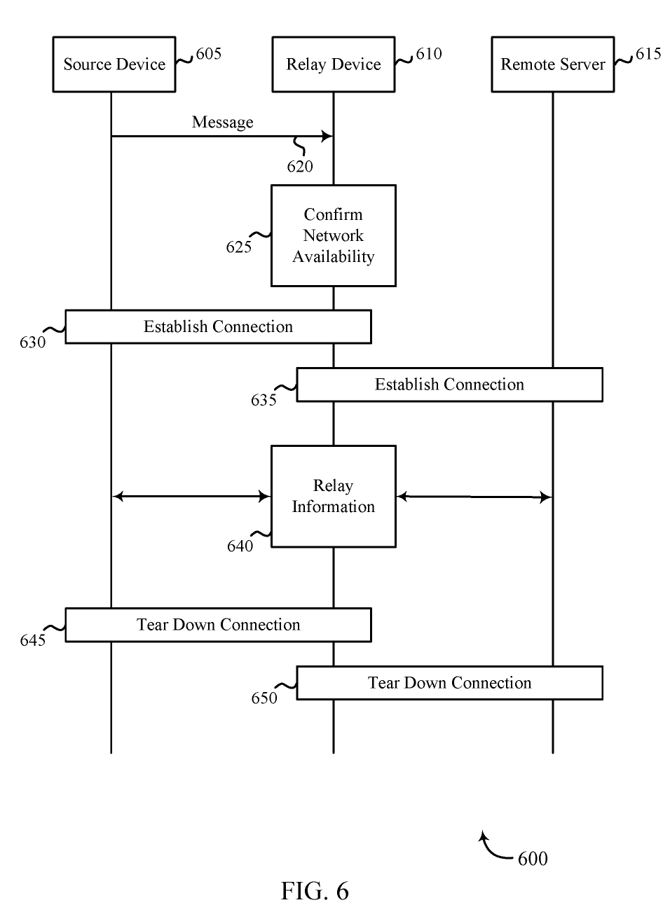

FIG. 6 shows a process flow 600 for relaying based on a service type indicator and network availability in accordance with various aspects of the present disclosure. Aspects of the process flow 600 may include a source device 605, a relay device 610, and a remote server 615. The source device 605 may be an example of the source devices 210 described with reference to FIG. 2. The relay device 610 may be an example of a UE 115 described with reference to FIGS. 1 through 5. The remote server 615 may be an example of the destination device 215 described with reference to FIG. 2.

The operations of process flow 600 may be implemented by a device such as a relay device 610 (e.g., a UE 115) or its components as described with reference to FIGS. 1 and 2. In some examples, the relay device 610 may execute a set of codes to control the functional elements of the device to perform the functions described below. Additionally or alternatively, the relay device 610 may perform aspects of the functions described below using special-purpose hardware. Generally, process flow 600 illustrates an example of end-to-end data forwarding in a concurrent connection scenario.

In the example process flow 600, the relay device 610 may support a concurrent connection to relay information between source device 605 and remote server 615. At 620, relay device 610 may receive a message from the source device 605. The message may be a broadcast message requesting a concurrent connection be established. The message may include a service type indicator that the relay device uses to determine the type of service the source device 605 is requesting. At 625, the relay device 610 may determine a capability configuration that includes a determination of whether there is network availability. If there is network availability, the relay device 610 may determine that it can support the requested service, as indicated in the service type indicator.

At 630, the relay device 610 may establish a connection with the source device 605. At 635, the relay device 610 may establish a connection with the remote server 615. Thus, the relay device 610 may have a concurrent connection between the source device 605 and the relay device 610 and between the relay device 610 and the remote server 615. At 640, the relay device 610 may relay information between the source device 605 and the remote server 615. Once the information has been relayed, the relay device 610 may tear down the connection with the source device 605 at 645 and with the remote server 615 at 650. In some aspects, the establishment of the connections and/or the tear down of the connections can occur in any order or simultaneously.

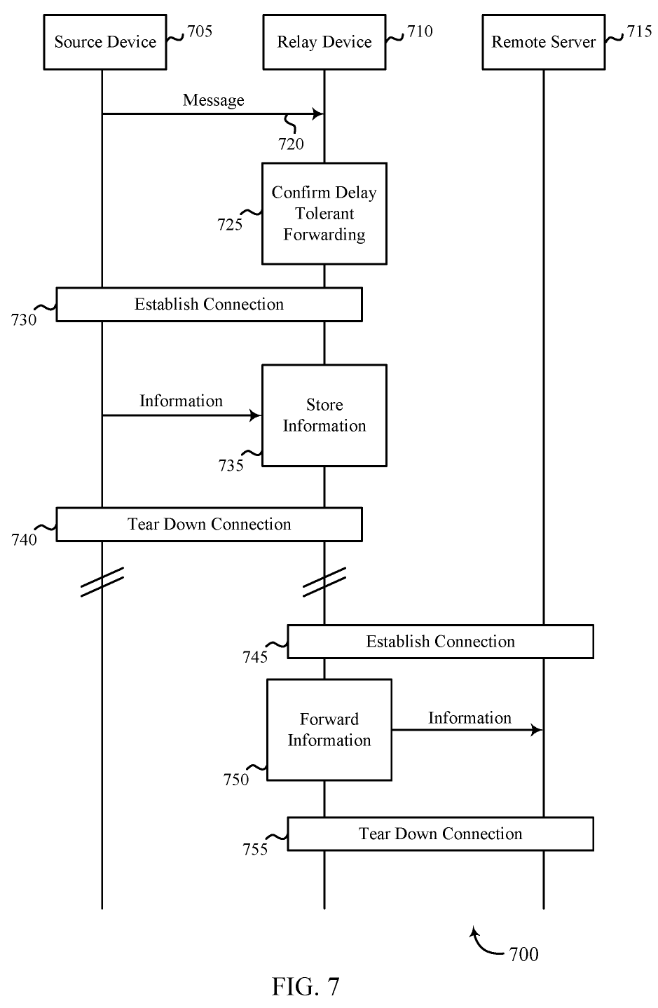

FIG. 7 shows a process flow 700 for relaying based on a service type indicator and network availability in accordance with various aspects of the present disclosure. Aspects of the process flow 700 may include a source device 705, a relay device 710, and a remote server 715. The source device 705 may be an example of the source devices 210 described with reference to FIG. 2. The relay device 710 may be an example of a UE 115 described with reference to FIGS. 1 through 5. The remote server 715 may be an example of the destination device 215 described with reference to FIG. 2.

The operations of process flow 700 may be implemented by a device such as a relay device 710 (e.g., a UE 115) or its components as described with reference to FIGS. 1 and 2. In some examples, the relay device 710 may execute a set of codes to control the functional elements of the device to perform the functions described below. Additionally or alternatively, the relay device 710 may perform aspects of the functions described below using special-purpose hardware. Generally, process flow 700 illustrates an example of delay tolerant message forwarding.

In the example process flow 700, the relay device 710 may support forwarding of a delay tolerant message from source device 705 to remote server 715. At 720, relay device 710 may receive a message from the source device 705. The message may be a broadcast message requesting a connection be established for message forwarding. The message may include a service type indicator that the relay device 710 uses to determine the type of service the source device 705 is requesting, forwarding of a delay tolerant message in this example. At 725, the relay device 710 may determine a capability configuration that includes a determination of whether there the relay device 710 support forwarding of delay tolerant messages. The relay device 710 may determine that it can support the requested service, as indicated in the service type indicator.

At 730, the relay device 710 may establish a connection with the source device 705. At 735, the relay device 710 may receive and store the delay tolerant message. At 740, the relay device 710 may tear down the connection with the source device 705. At some point later, at 745, the relay device 710 may establish a connection with the remote server 715. At 750, the relay device 710 may forward the stored information to the remote server 715. Once the information has been forwarded, the relay device 710 may tear down the connection with the remote server 715 at 755. In some aspects, the establishment of the connection to the remote server 715 may occur after the connection to the source device 705 has been torn down.

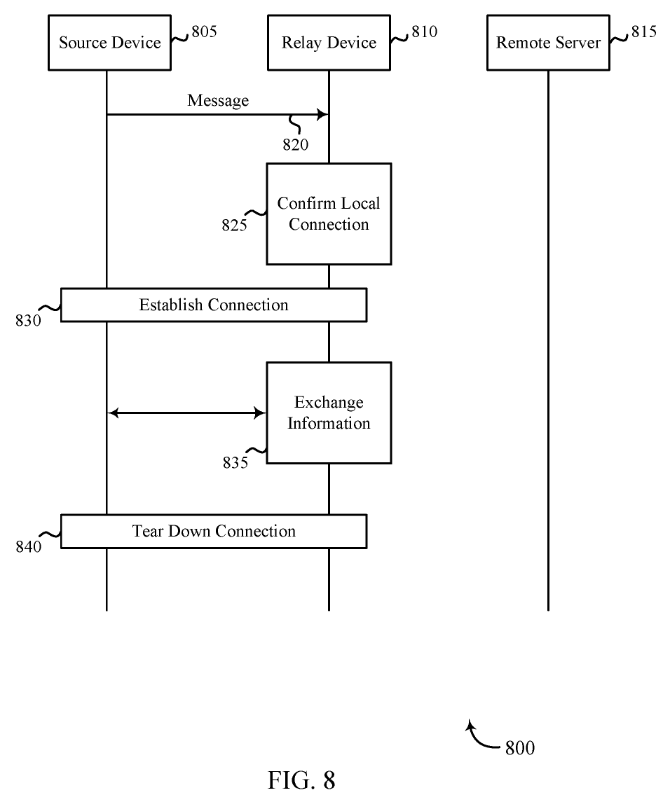

FIG. 8 shows a process flow 800 for relaying based on a service type indicator and network availability in accordance with various aspects of the present disclosure. Aspects of the process flow 800 may include a source device 805, a relay device 810, and a remote server 815. The source device 805 may be an example of the source devices 210 described with reference to FIG. 2. The relay device 810 may be an example of a UE 115 described with reference to FIGS. 1 through 5. The remote server 815 may be an example of the destination device 215 described with reference to FIG. 2.

The operations of process flow 800 may be implemented by a device such as a relay device 810 (e.g., a UE 115) or its components as described with reference to FIGS. 1 and 2. In some examples, the relay device 810 may execute a set of codes to control the functional elements of the device to perform the functions described below. Additionally or alternatively, the relay device 810 may perform aspects of the functions described below using special-purpose hardware. Generally, process flow 800 illustrates an example of the relay device 810 supporting a local connection with the source device 805.

In the example process flow 800, the relay device 810 may support a local connection with source device 805. At 820, relay device 810 may receive a message from the source device 805. The message may be a broadcast message requesting a local connection be established. The message may include a service type indicator that the relay device 810 uses to determine the type of service the source device 805 is requesting, a local connection in this example. At 825, the relay device 810 may determine a capability configuration that includes a determination of whether there the relay device 810 support the local connection with the source device 805. The relay device 810 may determine that it can support the requested service, as indicated in the service type indicator.

At 830, the relay device 810 may establish a connection with the source device 805. At 835, the relay device 810 may exchange information with the source device 805. At 840, the relay device 810 may tear down the connection with the source device 805.

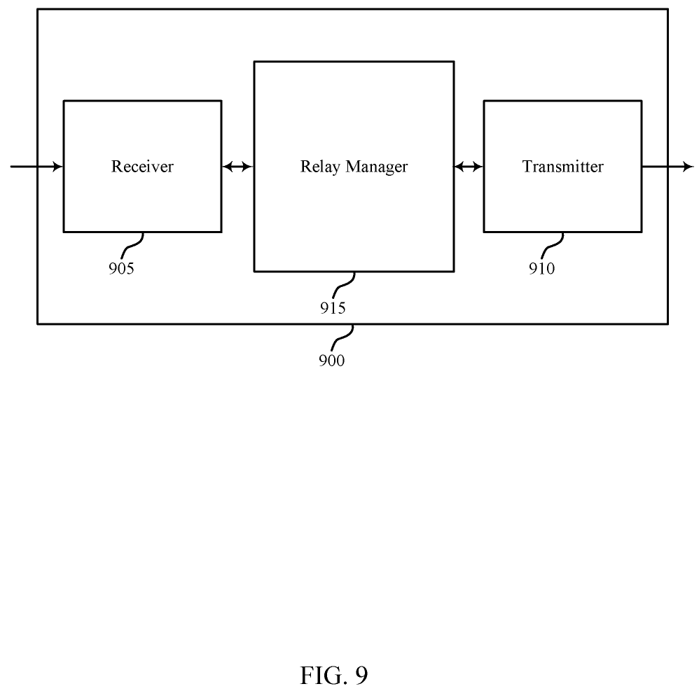

FIG. 9 shows a block diagram of a wireless device 900 that supports relaying based on service-type indicator and network availability in accordance with various aspects of the present disclosure. Wireless device 900 may be an example of aspects of a UE 115 and/or a relay device 610, 710, and 810 described with reference to FIGS. 1 through 8. Wireless device 900 may include a receiver 905, a transmitter 910 and a relay manager 915. Wireless device 900 may also include a processor. Each of these components may be in communication with each other.

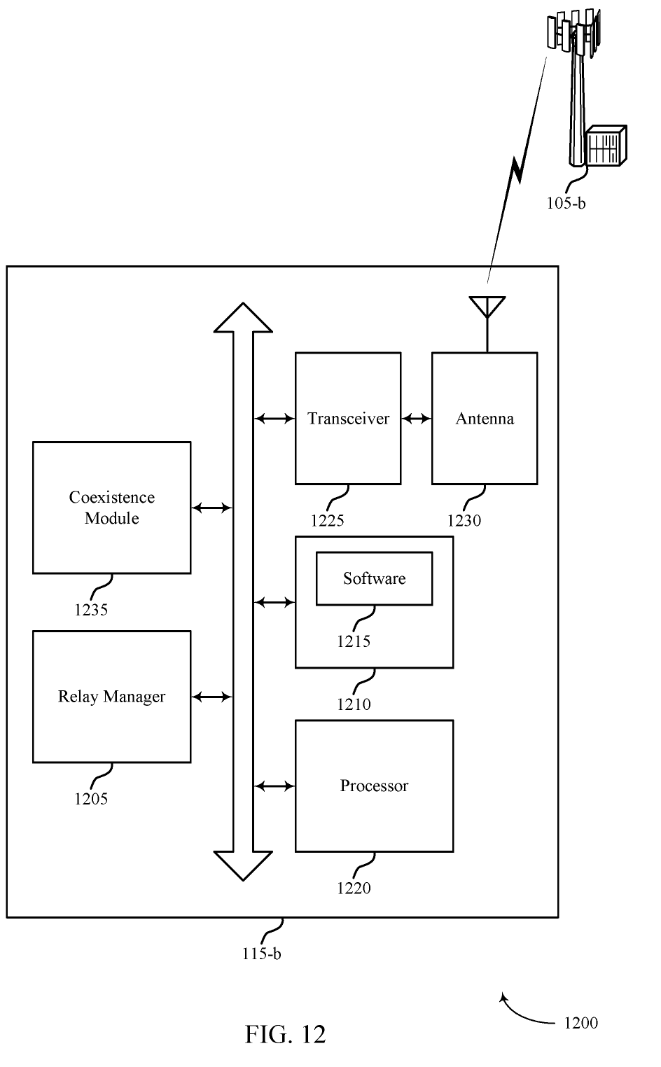

The receiver 905 may receive information such as packets, user data, or control information associated with various information channels (e.g., control channels, data channels, and information related to relaying based on service-type indicator and network availability, etc.). Information may be passed on to other components of the device. The receiver 905 may be an example of aspects of the transceiver 1225 described with reference to FIG. 12.

The transmitter 910 may transmit signals received from other components of wireless device 900. In some examples, the transmitter 910 may be collocated with a receiver in a transceiver module. For example, the transmitter 910 may be an example of aspects of the transceiver 1225 described with reference to FIG. 12. The transmitter 910 may include a single antenna, or it may include a plurality of antennas.

The relay manager 915 may receive a broadcast message from a source device on a first air interface, the broadcast message including a service type indicator, identify a capability configuration of the relay device, the capability configuration including information associated with communicating via the first air interface and at least a second air interface, and determine to establish a connection to the source device on the first air interface based on the capability configuration and the service type indicator. The relay manager 915 may also be an example of aspects of the relay manager 1205 described with reference to FIG. 12.

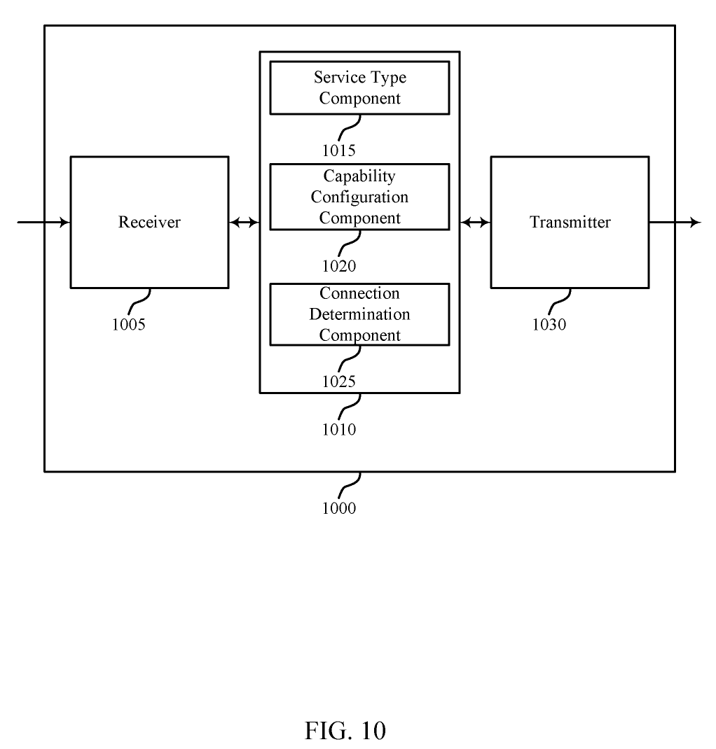

FIG. 10 shows a block diagram of a wireless device 1000 that supports relaying based on service-type indicator and network availability in accordance with various aspects of the present disclosure. Wireless device 1000 may be an example of aspects of a wireless device 900, a relay device 610, 710, or 810, or a UE 115 described with reference to FIGS. 1 through 9. Wireless device 1000 may include a receiver 1005, a relay manager 1010 and a transmitter 1030. Wireless device 1000 may also include a processor. Each of these components may be in communication with each other.

The receiver 1005 may receive information which may be passed on to other components of the device. The receiver 1005 may also perform the functions described with reference to the receiver 905 of FIG. 9. The receiver 1005 may be an example of aspects of the transceiver 1225 described with reference to FIG. 12.

The relay manager 1010 may be an example of aspects of relay manager 915 described with reference to FIG. 9. The relay manager 1010 may include a service type component 1015, a capability configuration component 1020 and a connection determination component 1025. The relay manager 1010 may be an example of aspects of the relay manager 1205 described with reference to FIG. 12.

The service type component 1015 may receive a broadcast message from a source device on a first air interface, the broadcast message including a service type indicator. In some cases, the service type indicator includes an indication of at least one of a concurrent connection request on the first air interface and the second air interface, a delay tolerant message forwarding request, a request for information, or combinations thereof. In some cases, the broadcast message includes a connection request message. In some cases, at least one of the first connection or the second connection includes a connection over a licensed radio frequency spectrum band. In some cases, at least one of the first connection or the second connection includes a connection over an unlicensed radio frequency spectrum band.

The capability configuration component 1020 may identify a capability configuration of the relay device, the capability configuration including information associated with communicating via the first air interface and at least a second air interface. In some cases, the capability configuration includes an indication of one or more services supported by the relay device via at least one of the first air interface and the second air interface. In some cases, at least one of the first air interface or the second air interface includes a connection over a same air interface. In some cases, at least one of the first air interface or the second air interface includes a connection over a different air interface.

The connection determination component 1025 may determine to establish a connection to the source device on the first air interface based on the capability configuration and the service type indicator.

The transmitter 1030 may transmit signals received from other components of wireless device 1000. In some examples, the transmitter 1030 may be collocated with a receiver in a transceiver module. For example, the transmitter 1030 may be an example of aspects of the transceiver 1225 described with reference to FIG. 12. The transmitter 1030 may utilize a single antenna, or it may utilize a plurality of antennas.

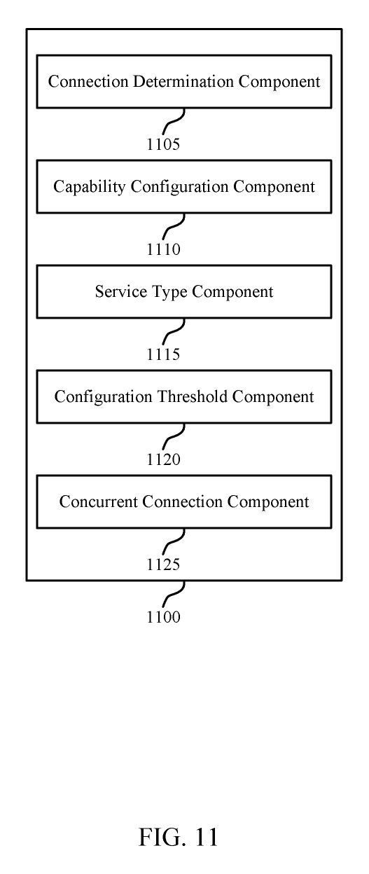

FIG. 11 shows a block diagram of a relay manager 1100 which may be an example of the corresponding component of wireless device 900 or wireless device 1000. That is, relay manager 1100 may be an example of aspects of the relay manager 915 or the relay manager 1010 described with reference to FIGS. 9 and 10. The relay manager 1100 may also be an example of aspects of the relay manager 1205 described with reference to FIG. 12.

The relay manager 1100 may include a connection determination component 1105, a capability configuration component 1110, a service type component 1115, a configuration threshold component 1120 and a concurrent connection component 1125. Each of these modules may communicate, directly or indirectly, with one another (e.g., via one or more buses).

The connection determination component 1105 may determine to establish a connection to the source device on the first air interface based on the capability configuration and the service type indicator. The capability configuration component 1110 may identify a capability configuration of the relay device, the capability configuration including information associated with communicating via the first air interface and at least a second air interface.

The service type component 1115 may receive a broadcast message from a source device on a first air interface, the broadcast message including a service type indicator. The configuration threshold component 1120 may determine a threshold level and determine to establish a connection to the source device based on the capability configuration being within a threshold level of a requested service indicated by the service type indicator.

The concurrent connection component 1125 may identify a concurrent connection request, the concurrent connection including a first connection between the relay device and the source device on the first air interface and a second connection between the relay device and a remote server on the second air interface.

FIG. 12 shows a diagram of a system 1200 including a device that supports relaying based on service-type indicator and network availability in accordance with various aspects of the present disclosure. For example, system 1200 may include a UE 115-b, which may be an example of a relay device 610, 710, or 810, a wireless device 900, a wireless device 1000, or a UE 115 as described with reference to FIGS. 1 through 11.

UE 115-b may also include a relay manager 1205, a memory 1210, a processor 1220, a transceiver 1225, an antenna 1230 and a coexistence module 1235. Each of these modules may communicate, directly or indirectly, with one another (e.g., via one or more buses). The relay manager 1205 may be an example of a relay manager as described with reference to FIGS. 9 through 11.

The memory 1210 may include random access memory (RAM) and read only memory (ROM). The memory 1210 may store computer-readable, computer-executable software including instructions that, when executed, cause the processor to perform various functions described herein (e.g., relaying based on service-type indicator and network availability, etc.). In some cases, the software 1215 may not be directly executable by the processor but may cause a computer (e.g., when compiled and executed) to perform functions described herein. The processor 1220 may include an intelligent hardware device, (e.g., a central processing unit (CPU), a microcontroller, an application specific integrated circuit (ASIC), etc.)

The transceiver 1225 may communicate bi-directionally, via one or more antennas, wired, or wireless links, with one or more networks, as described above. For example, the transceiver 1225 may communicate bi-directionally with a base station 105-b or another UE 115. The transceiver 1225 may also include a modem to modulate the packets and provide the modulated packets to the antennas for transmission, and to demodulate packets received from the antennas. In some cases, the wireless device may include a single antenna 1230. However, in some cases the device may have more than one antenna 1230, which may be capable of concurrently transmitting or receiving multiple wireless transmissions.

Coexistence module 1235 may enable operations in a wireless environment comprising networks utilizing multiple RATs such as an wireless wide area network (WWAN) and a wireless local area network (WLAN).

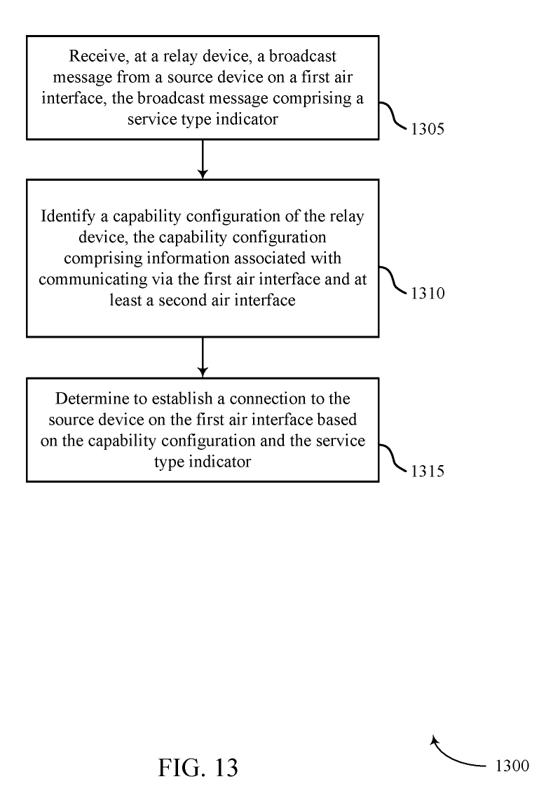

FIG. 13 shows a flowchart illustrating a method 1300 for relaying based on service-type indicator and network availability in accordance with various aspects of the present disclosure. The operations of method 1300 may be implemented by a device such as a UE 115 or a relay device 610, 710, or 810, or its components, as described with reference to FIGS. 1 through 8. For example, the operations of method 1300 may be performed by the relay manager as described herein. In some examples, the UE 115 may execute a set of codes to control the functional elements of the device to perform the functions described below. Additionally or alternatively, the UE 115 may perform aspects the functions described below using special-purpose hardware.

At block 1305, the UE 115 may receive a broadcast message from a source device on a first air interface, the broadcast message including a service type indicator as described above with reference to FIGS. 2 through 8. In certain examples, the operations of block 1305 may be performed by the service type component as described with reference to FIGS. 10 and 11.

At block 1310, the UE 115 may identify a capability configuration of the relay device, the capability configuration including information associated with communicating via the first air interface and at least a second air interface as described above with reference to FIGS. 2 through 8. In certain examples, the operations of block 1310 may be performed by the capability configuration component as described with reference to FIGS. 10 and 11.

At block 1315, the UE 115 may determine to establish a connection to the source device on the first air interface based on the capability configuration and the service type indicator as described above with reference to FIGS. 2 through 8. In certain examples, the operations of block 1315 may be performed by the connection determination component as described with reference to FIGS. 10 and 11.

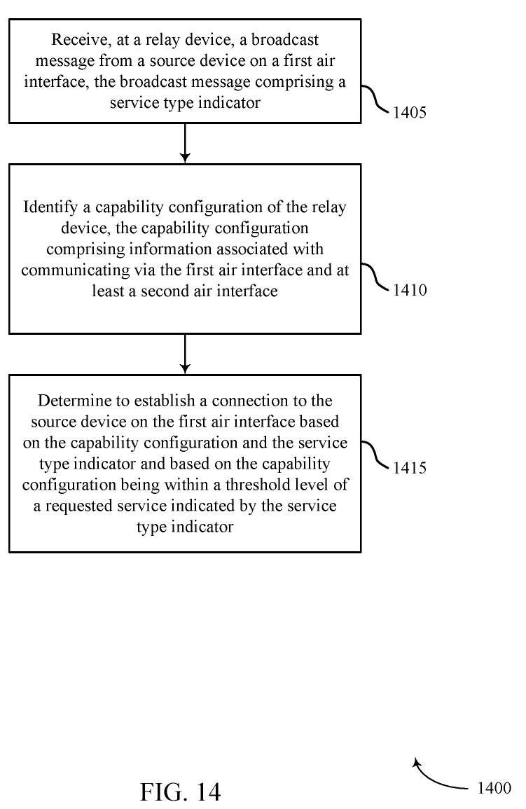

FIG. 14 shows a flowchart illustrating a method 1400 for relaying based on service-type indicator and network availability in accordance with various aspects of the present disclosure. The operations of method 1400 may be implemented by a device such as a UE 115, or a relay device 610, 710, or 810, or its components, as described with reference to FIGS. 1 through 8. For example, the operations of method 1400 may be performed by the relay manager as described herein. In some examples, the UE 115 may execute a set of codes to control the functional elements of the device to perform the functions described below. Additionally or alternatively, the UE 115 may perform aspects the functions described below using special-purpose hardware.

At block 1405, the UE 115 may receive a broadcast message from a source device on a first air interface, the broadcast message including a service type indicator as described above with reference to FIGS. 2 through 8. In certain examples, the operations of block 1405 may be performed by the service type component as described with reference to FIGS. 10 and 11.

At block 1410, the UE 115 may identify a capability configuration of the relay device, the capability configuration including information associated with communicating via the first air interface and at least a second air interface as described above with reference to FIGS. 2 through 8. In certain examples, the operations of block 1410 may be performed by the capability configuration component as described with reference to FIGS. 10 and 11.

At block 1415, the UE 115 may determine to establish a connection to the source device on the first air interface based on the capability configuration and the service type indicator as described above with reference to FIGS. 2 through 8. In some cases, the UE 115 may determine to establish the connection to the source device based on the capability configuration being within a threshold level of a requested service indicated by the service type indicator. In certain examples, the operations of block 1415 may be performed by the connection determination component as described with reference to FIGS. 10 and 11.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for relaying based on service-type indicator and network availability.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical (physical) locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers (CCs)). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

Thus, aspects of the disclosure may provide for relaying based on service-type indicator and network availability. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
receiving, at a relay device, a broadcast message from a source device on a first air interface, the broadcast message comprising a service type indicator;
identifying a capability configuration of the relay device, the capability configuration comprising information associated with communicating via the first air interface and at least a second air interface; and
determining to establish a connection to the source device on the first air interface based at least in part on the capability configuration and the service type indicator.

2. The method of claim 1, further comprising:
determining to establish the connection to the source device based at least in part on the capability configuration being within a threshold level of a requested service indicated by the service type indicator.

3. The method of claim 1, wherein the service type indicator comprises an indication of at least one of a concurrent connection request on the first air interface and the second air interface, a delay tolerant message forwarding request, a request for information, or combinations thereof.

4. The method of claim 1, wherein the capability configuration comprises an indication of one or more services supported by the relay device via at least one of the first air interface and the second air interface.

5. The method of claim 1, wherein the broadcast message comprises a connection request message.

6. The method of claim 1, wherein the service type indicator comprises a concurrent connection request, the concurrent connection comprising a first connection between the relay device and the source device on the first air interface and a second connection between the relay device and a remote server on the second air interface.

7. The method of claim 6, wherein at least one of the first air interface or the second air interface comprises a connection over a same air interface.

8. The method of claim 6, wherein at least one of the first air interface or the second air interface comprises a connection over a different air interface.

9. The method of claim 6, wherein at least one of the first connection or the second connection comprises a connection over a licensed radio frequency spectrum band.

10. The method of claim 6, wherein at least one of the first connection or the second connection comprises a connection over an unlicensed radio frequency spectrum band.

11. An apparatus for wireless communication comprising:
means for receiving, at a relay device, a broadcast message from a source device on a first air interface, the broadcast message comprising a service type indicator;
means for identifying a capability configuration of the relay device, the capability configuration comprising information associated with communicating via the first air interface and at least a second air interface; and
means for determining to establish a connection to the source device on the first air interface based at least in part on the capability configuration and the service type indicator.

12. The apparatus of claim 11, further comprising:
means for determining to establish the connection to the source device based at least in part on the capability configuration being within a threshold level of a requested service indicated by the service type indicator.

13. The apparatus of claim 11, wherein the service type indicator comprises an indication of at least one of a concurrent connection request on the first air interface and the second air interface, a delay tolerant message forwarding request, a request for information, or combinations thereof.

14. The apparatus of claim 11, wherein the capability configuration comprises an indication of one or more services supported by the relay device via at least one of the first air interface and the second air interface.

15. The apparatus of claim 11, wherein the broadcast message comprises a connection request message.

16. The apparatus of claim 11, wherein the service type indicator comprises a concurrent connection request, the concurrent connection comprising a first connection between the relay device and the source device on the first air interface and a second connection between the relay device and a remote server on the second air interface.

17. The apparatus of claim 16, wherein at least one of the first air interface or the second air interface comprises a connection over a same air interface.

18. The apparatus of claim 16, wherein at least one of the first air interface or the second air interface comprises a connection over a different air interface.

19. The apparatus of claim 16, wherein at least one of the first connection or the second connection comprises a connection over a licensed radio frequency spectrum band.

20. The apparatus of claim 16, wherein at least one of the first connection or the second connection comprises a connection over an unlicensed radio frequency spectrum band.

21. An apparatus for wireless communication, comprising:
a processor;
memory in electronic communication with the processor; and
instructions stored in the memory and operable, when executed by the processor, to cause the apparatus to:
receive, at a relay device, a broadcast message from a source device on a first air interface, the broadcast message comprising a service type indicator;
identify a capability configuration of the relay device, the capability configuration comprising information associated with communicating via the first air interface and at least a second air interface; and
determine to establish a connection to the source device on the first air interface based at least in part on the capability configuration and the service type indicator.

22. The apparatus of claim 21, wherein the instructions are operable to cause the processor to:
determine to establish the connection to the source device based at least in part on the capability configuration being within a threshold level of a requested service indicated by the service type indicator.

23. The apparatus of claim 21, wherein the service type indicator comprises an indication of at least one of a concurrent connection request on the first air interface and the second air interface, a delay tolerant message forwarding request, a request for information, or combinations thereof.

24. The apparatus of claim 21, wherein the capability configuration comprises an indication of one or more services supported by the relay device via at least one of the first air interface and the second air interface.

25. The apparatus of claim 21, wherein the broadcast message comprises a connection request message.

26. The apparatus of claim 21, wherein the service type indicator comprises a concurrent connection request, the concurrent connection comprising a first connection between the relay device and the source device on the first air interface and a second connection between the relay device and a remote server on the second air interface.

27. The apparatus of claim 26, wherein at least one of the first air interface or the second air interface comprises a connection over a same air interface.

28. The apparatus of claim 26, wherein at least one of the first air interface or the second air interface comprises a connection over a different air interface.

29. The apparatus of claim 26, wherein at least one of the first connection or the second connection comprises a connection over a licensed radio frequency spectrum band.

30. A non-transitory computer-readable medium storing code for wireless communication, the code comprising instructions executable to:
receive, at a relay device, a broadcast message from a source device on a first air interface, the broadcast message comprising a service type indicator;
identify a capability configuration of the relay device, the capability configuration comprising information associated with communicating via the first air interface and at least a second air interface; and
determine to establish a connection to the source device on the first air interface based at least in part on the capability configuration and the service type indicator.
